(19) United States
(12) Patent Application Publication
(10) Pub. No.: US 2013/0219125 A1
(43) Pub. Date: Aug. 22, 2013

(54) CACHE EMPLOYING MULTIPLE PAGE REPLACEMENT ALGORITHMS

(71) Applicants: Norbert P. Kusters, Redmond, WA (US); Andrea D'Amato, Kirkland, WA (US); Vinod R. Shankar, Woodinville, WA (US)

(72) Inventors: Norbert P. Kusters, Redmond, WA (US); Andrea D'Amato, Kirkland, WA (US); Vinod R. Shankar, Woodinville, WA (US)

(73) Assignee: MICROSOFT CORPORATION, Redmond, WA (US)

(21) Appl. No.: 13/401,104

(22) Filed: Feb. 21, 2012

(51) Int. Cl. G06F 12/12

(52) U.S. Cl. 711/136; 711/133; 711/E12.071; 711/E12.07

(57) ABSTRACT

The present invention extends to methods, systems, and computer program products for implementing a cache using multiple page replacement algorithms. An exemplary cache can include two logical portions where the first portion implements the least recently used (LRU) algorithm and the second portion implements the least recently used two (LRU2) algorithm to perform page replacement within the respective portion. By implementing multiple algorithms, a more efficient cache can be implemented where the pages most likely to be accessed again are retained in the cache. Multiple page replacement algorithms can be used in any cache including an operating system cache for caching pages accessed via buffered I/O, as well as a cache for caching pages accessed via unbuffered I/O such as accesses to virtual disks made by virtual machines.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

Computer systems employ caching to speed up access to files. When an application requests access to a file on disk, the computer system (e.g. the operating system) can retrieve the file (or the requested portions (pages) of the file) and store the file (or portions) in a cache (e.g. in system memory). Subsequent accesses to the file can then be performed by accessing the file in cache rather than from the disk. Because accessing cache is much faster than accessing the disk, performance is improved especially when the file is frequently accessed.

A cache can be implemented using various different page replacement algorithms. A common algorithm is the Least Recently Used (LRU) algorithm. In the LRU algorithm, pages are stored in the cache based on the last time they were accessed. When a page is to be cached (and the cache is full), the LRU algorithm will determine which page in the cache was least recently used and discard that page to make room for the page to be cached. For example, it may be that a cache stores three pages, page 1 that was accessed 10 seconds ago, page 2 that was accessed 20 seconds ago, and page 3 that was accessed 30 seconds ago. Thus, when a new page is to be cached, page 3 will be discarded to make room for the new page to be cached because page 3 was least recently accessed.

Another common algorithm, which is a variation on the LRU algorithm, is the LRU2 algorithm. The LRU2 algorithm is similar to the LRU algorithm except that the second to last access of the page is used to determine which page is to be discarded from the cache. Using the same example as above, it may be that page 1 was accessed 10 seconds ago and 2 minutes ago, page 2 was accessed 20 seconds ago and 21 seconds ago, and page 3 was accessed 30 seconds ago and 35 seconds ago. As such, when a new page is to be cached, page 1 would be discarded using the LRU2 algorithm because page 2's second to last access was the least recent. Additional variations on the LRU algorithm include LRU3 (which uses the third to last access), LRU4 (which uses the fourth to last access), etc.

One problem with the LRU algorithm occurs when many files are accessed a single time such as when a file scan is performed. For example, during a file scan (e.g. a malware scan), every file is accessed. Thus, pages of files that are not likely to be accessed again within a short time are cached. The caching of such pages causes other pages that are likely to be accessed again to be discarded from the cache. For this reason, LRU2 is often used instead of LRU because LRU2 looks at the second to last access rather than the last access to determine which page is discarded from cache.

With respect to caching, operating systems provide two general modes of I/O which are referred to as buffered I/O and unbuffered I/O in this specification. Buffered I/O refers to I/O requests that are processed by the operating system by using caching techniques (i.e. the data obtained by the I/O is cached in memory). Unbuffered I/O refers to I/O requests that are processed by the operating system without employing caching (i.e. the requested data is always obtained from disk). Accordingly, an application can request that the operating system obtain data by using either a buffered I/O request or an unbuffered I/O request.

Some types of files are always accessed via unbuffered I/O. For example, in a system that hosts virtual machines, virtual machines access virtual disks via unbuffered I/O. In one environment, a parent virtual disk exists from which many virtual machines are executed. The parent virtual disk stores the operating system and applications used by each virtual machine. Additionally, a child virtual disk can be created for each virtual machine.

Each virtual machine uses its child virtual disk to store virtual machine specific data (such as word processing documents created on the virtual machine or any other changes the virtual machine desires to make to the parent virtual disk). In other words, the parent virtual disk is a read-only virtual disk. In contrast, any time a virtual machine needs to modify the content of the parent virtual disk (e.g. storing a new file on the virtual disk), the modification is made to the virtual machine's child virtual disk. The child virtual disks can also be referred to as differencing disks.

A virtual machine accesses the parent virtual disk as well as its child virtual disk via unbuffered I/O. Accordingly, the accessed pages of these virtual disks are not cached on the computer system where the virtual machines are hosted. Because many virtual machines executing on the same server access many of the same pages from the parent virtual disk, I/O performance can suffer. In other words, each time a virtual machine accesses a particular page from the parent virtual disk, the page must be accessed from the physical disk (as opposed to the cache). In a virtual machine environment, the physical disk is often physically located separate from the computer system (e.g. in a storage array connected to a server over a network) leading to a greater decrease in performance.

FIG. 1 (Prior Art) illustrates a typical computer environment 100 for hosting virtual machines. Environment 100 includes a plurality of server nodes (101a-101n) that are each connected to a storage array 102. Each of server nodes 101a-101n hosts a plurality of virtual machines that access a parent virtual disk 104 that is stored in storage array 102 over connection 103. Connection 103 can be any type of connection between a server node and storage array 102 including direct or network connections. In addition to parent virtual disk 104, a child virtual disk is also stored on storage array 102 for each virtual machine on each of server nodes 101a-101n.

When a virtual machine accesses a virtual disk (either the parent or child), the access is performed via unbuffered I/O (i.e. by accessing storage array 102 as opposed to cache in local memory). Because of the many virtual machines (e.g. 1000 per server node) accessing the parent and their respective child virtual disk stored on storage array 102, a large number of I/O requests are made over connection 103 to storage array 102. This is so even if virtual machines on the same server node are accessing the same pages of the parent virtual disk because these accesses are performed via unbuffered I/O such that the accessed pages are not cached in memory of the corresponding server node.

### BRIEF SUMMARY

The present invention extends to methods, systems, and computer program products for implementing a cache using multiple page replacement algorithms. By implementing multiple algorithms, a more efficient cache can be implemented where the pages most likely to be accessed again are retained in the cache. Multiple page replacement algorithms can be used in any cache including an operating system cache for caching pages accessed via buffered I/O, as well as a cache for caching pages accessed via unbuffered I/O such as accesses to virtual disks made by virtual machines.

In one embodiment, a cache that employs multiple page replacement algorithms is implemented by maintaining a first logical portion of a cache using a first page replacement algorithm to replace pages in the first logical portion. A second logical portion of the cache is also maintained that uses a second page replacement algorithm to replace pages in the second logical portion. When a first page is to be replaced in the first logical portion, the first page is moved from the first logical portion to the second logical portion of the cache if the first page has been accessed at least a minimum number of times required to be considered for caching in the second logical portion.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a prior art computer environment in which virtual machines are hosted;

FIG. 2 illustrates an example computer architecture that facilitates implementing a cache that uses multiple page replacement algorithms;

FIGS. 3A and 3B illustrate an exemplary logical arrangement of a cache that employs multiple page replacement algorithms;

FIG. 4 illustrates a flowchart of an exemplary method for implementing a cache that employs multiple page replacement algorithms; and

FIG. 5 illustrates an exemplary server architecture in which a cache that employs multiple page replacement algorithms may be used.

### DETAILED DESCRIPTION

The present invention extends to methods, systems, and computer program products for implementing a cache using multiple page replacement algorithms. By implementing multiple algorithms, a more efficient cache can be implemented where the pages most likely to be accessed again are retained in the cache. Multiple page replacement algorithms can be used in any cache including an operating system cache for caching pages accessed via buffered I/O, as well as a cache for caching pages accessed via unbuffered I/O such as accesses to virtual disks made by virtual machines.

In one embodiment, a cache that employs multiple page replacement algorithms is implemented by maintaining a first logical portion of a cache using a first page replacement algorithm to replace pages in the first logical portion. A second logical portion of the cache is also maintained that uses a second page replacement algorithm to replace pages in the second logical portion. When a first page is to be replaced in the first logical portion, the first page is moved from the first logical portion to the second logical portion of the cache if the first page has been accessed at least a minimum number of times required to be considered for caching in the second logical portion.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

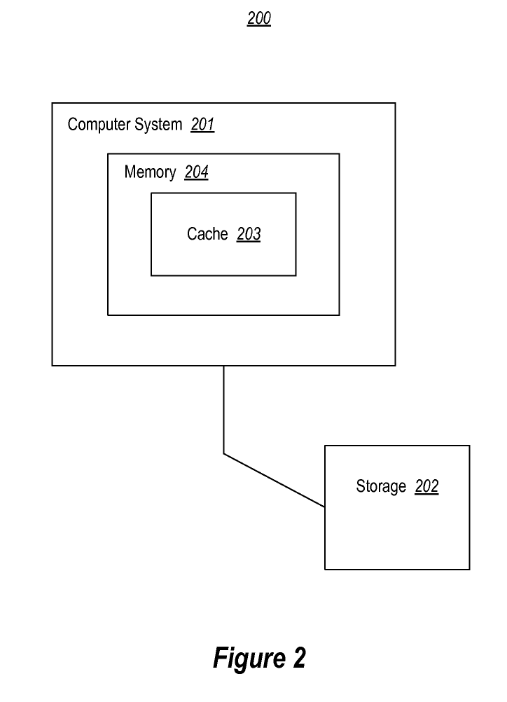

FIG. 2 illustrates an example computer architecture 200 that facilitates implementing a cache that uses multiple page replacement algorithms. Referring to FIG. 2, computer architecture 200 includes computer system 201. Computer system 201 can be connected to other computer systems over a network, such as, for example, a Local Area Network (“LAN”), a Wide Area Network (“WAN”), and even the Internet. Accordingly, computer system 201 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Computer system 201 includes or is connected to storage 202. For example, storage 202 can be an internal hard drive or a storage array. Storage 202 can store any type of data including operating system files, application files, virtual hard disk images, etc. Computer system 201 also includes cache 203. Cache 203 can be implemented with any type of quickly accessed storage media, but is typically implemented in memory (e.g. memory 204).

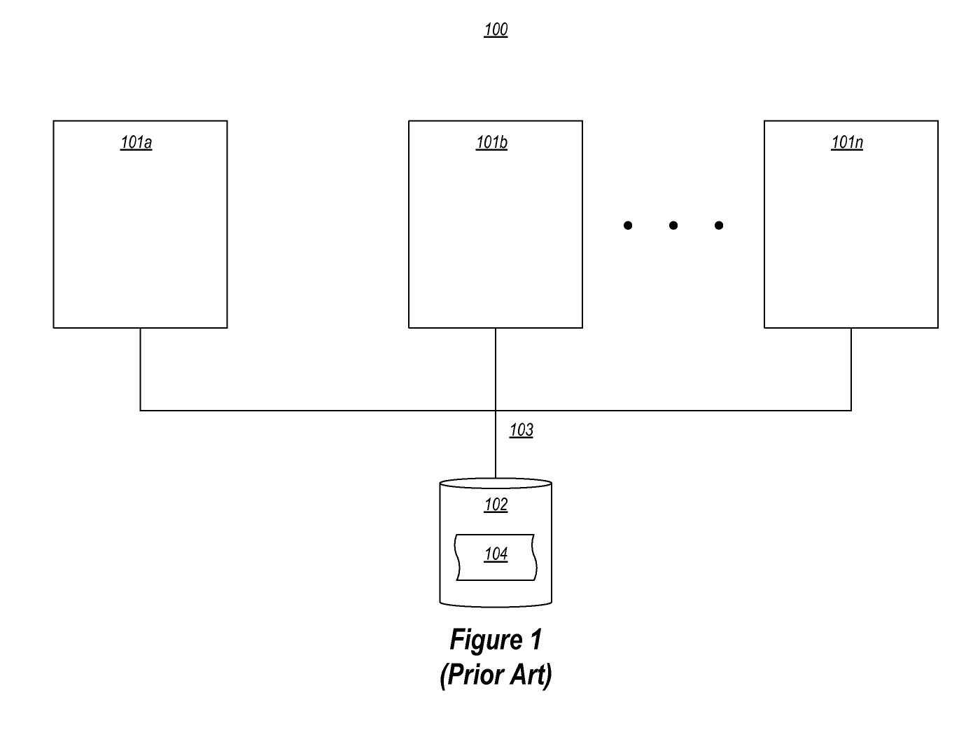

Computer system 201 can represent a typical desktop, laptop, tablet, or other portable computer, in which case storage 202 can be an internal hard drive. Computer system 201 can also represent a node of a cluster of servers in which case storage 202 can be a storage array (e.g. similar to storage array 102 of FIG. 1) to which one or more other nodes could be connected. Accordingly, the caching techniques of the present invention can be applied within any computer environment which employs caching.

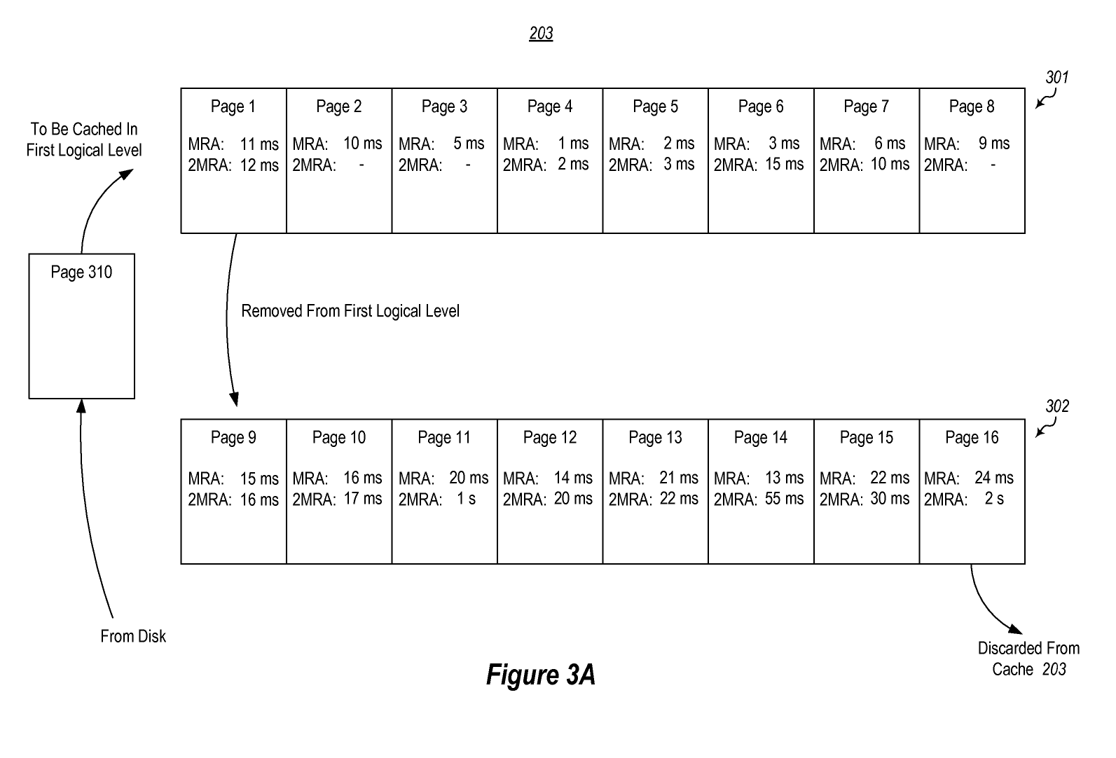

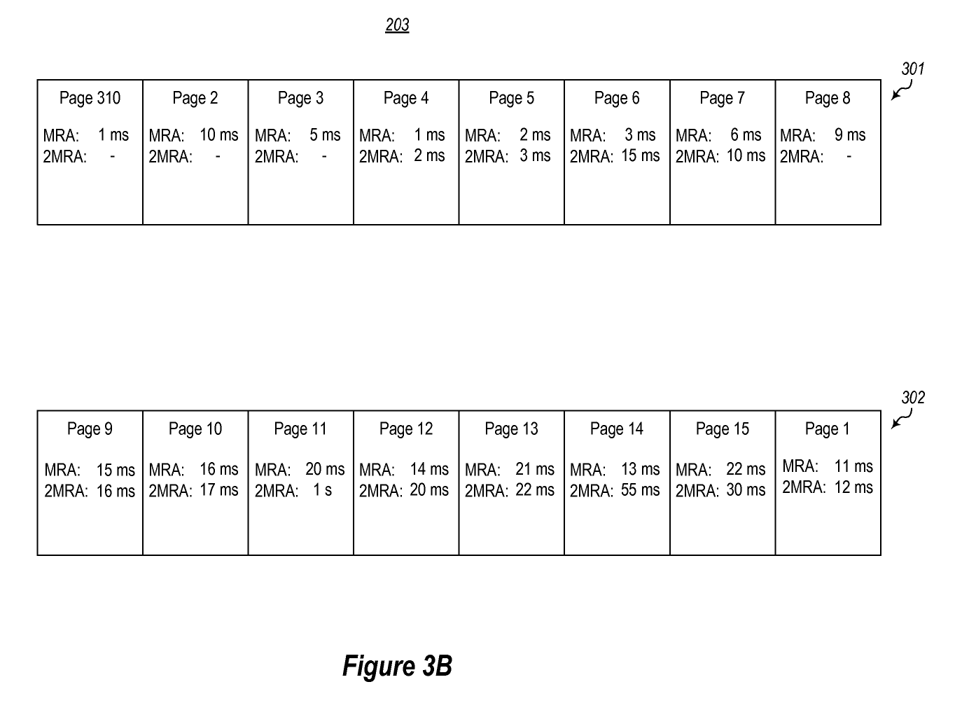

FIG. 3A illustrates how cache 203 can be logically configured to use multiple page replacement algorithms according to a first embodiment. Although FIG. 3 depicts two portions of contiguous memory, the actual location where pages are cached is not important. In other words, FIG. 3A only depicts the logical structure of the cache. The actual physical placement scheme used to cache pages in memory would vary depending on the type of hardware used and other factors. FIG. 3A also illustrates that the first and second portions are the same size; however, the respective sizes may be different in some embodiments.

The embodiment depicted in FIG. 3A employs two page replacement algorithms. On a first logical level (301), LRU is used, and on a second logical level (302), LRU2 is used. The first logical level implements LRU (i.e. a page is removed from the first logical level when it is the least recently used page in the first logical level). However, when a page is to be replaced in the first logical level, rather than discarding the page from cache 203, it is first checked to see when the page's second most recent access occurred. Based on this second most recent access and according to the LRU2 algorithm, the page can be placed in the second logical level of cache 203. Otherwise, if the page in the first logical level has not been accessed at least two times during the monitored time period, the page will be discarded from the cache.

In FIG. 3A, the most recent access of a page is abbreviated as MRA and the second most recent access is abbreviated as 2MRA. FIG. 3A represents the occurrence of an access with the duration of time (in seconds) since the access, however, a timestamp or other way of identifying when the access occurred could equally be used. Also, the information identifying when a page was accessed can be stored in conjunction with the page (e.g. as metadata), separate from the pages (e.g. in a centralized data structure), or in any other suitable manner. Further, the occurrence of additional less recent accesses can also be stored (e.g. when higher orders of LRU (LRU3, LRU4, etc.) are implemented). In other implementations, a linked list can be employed where the pages in a logical level are ordered within the list based on when each page was last accessed. In such implementations, the last page in the linked list is the least recently used page. Accordingly, the manner in which each page replacement algorithm is implemented within a logical level is not essential to the invention.

As shown in FIG. 3A, page 310 has been accessed from disk and is to be cached in cache 203. The access to disk can be to either read or write page 310. It is noted that page 310 could also come from another logical level of cache 203 such as if the page is already cached in the second logical level when it is requested.

Because the first logical level of cache 203 is full, it is necessary to discard a page from the first logical level to make room for page 310. To determine which page is discarded, the LRU algorithm is applied to discard the page that was least recently used. In FIG. 3A, the least recently used page would be page 1 because page 1's MRA is 11 ms which is the least recent of the MRAs of all other pages in the first logical level.

Rather than discarding page 1 from cache 203, it will first be determined whether page 1 should be cached in the second logical level of cache 203 based on the LRU2 algorithm. This is done by comparing page 1's second most recent access (2MRA) to the 2MRAs of the other pages cached in the second logical level. If page 1 does not include a 2MRA (e.g. if page 1 has only been accessed once during the monitored time) or if its 2MRA is the least recent of the 2MRAs of the other pages in the second logical level, it will be discarded from cache 203. Otherwise, the page having the 2MRA that is the least recent of the 2MRAs of the other pages in the second logical level will be discarded to make room for page 1 within the second logical level.

As shown in FIG. 3A, page 16 has a 2MRA (2 seconds) that is the least recent of the pages in the second logical level. Additionally, page 1's 2MRA is more recent (12 ms) than page 16's 2MRA. Accordingly, page 1 will be cached in the second logical level and page 16 will be discarded.

FIG. 3B illustrates cache 203 after page 310 has been cached. As shown page 310 appears in the first logical level, page 1 has been moved to the second logical level, and page 16 is no longer cached.

As another example, if another page were to be cached after page 310 has been cached, page 2 would be removed from the first logical level because its MRA (10 ms) is the least recently used. Because page 2 has not been accessed twice during the monitored time, it does not have a 2MRA. Accordingly, page 2 would be discarded from cache 203 rather than moved into the second logical level. A similar result would occur if page 2 had a 2MRA that was greater than 1 second because the least recent 2MRA in the second logical level is 1 second (page 11). Therefore, the LRU2 algorithm would dictate that page 2 would not be cached in the second logical level in this example.

It is noted that FIGS. 3A-3B only represent logically how pages are moved into, within, or from cache 203. In some embodiments, when a page is moved from one logical level to another, the page will not actually be physically moved. In other words, the page will physically remain in the same location in the cache, but will logically be moved to another location (e.g. by being associated with a data structure (e.g. a linked list) representing the second logical level and removed from a data structure (e.g. a linked list) representing the first logical level). In such embodiments, the example of FIGS. 3A-3B could be implemented by discarding page 16 from cache 203, caching page 310 where page 16 was cached, and updating any data structures accordingly.

In some embodiments, additional logical levels can be used. For example, a third logical level that employs the LRU3 algorithm (which uses the third most recent access to determine page replacement) can be implemented in cache 203. In such embodiments, pages that are discarded from the second logical level can be cached in the third logical level according to the LRU3 algorithm (assuming the pages have been accessed a sufficient number of times (i.e. three times)). A fourth logical level, fifth logical level, etc. can also be used which implement LRU4, LRU5, respectively. In any case, when a page is removed from one level, it can be considered for caching in the lower level if it has been accessed the required number of time (e.g. two for LRU2, three for LRU3, four for LRU4, etc.). In some embodiments, the number of logical levels that are implemented within cache 203 can be a configurable setting.

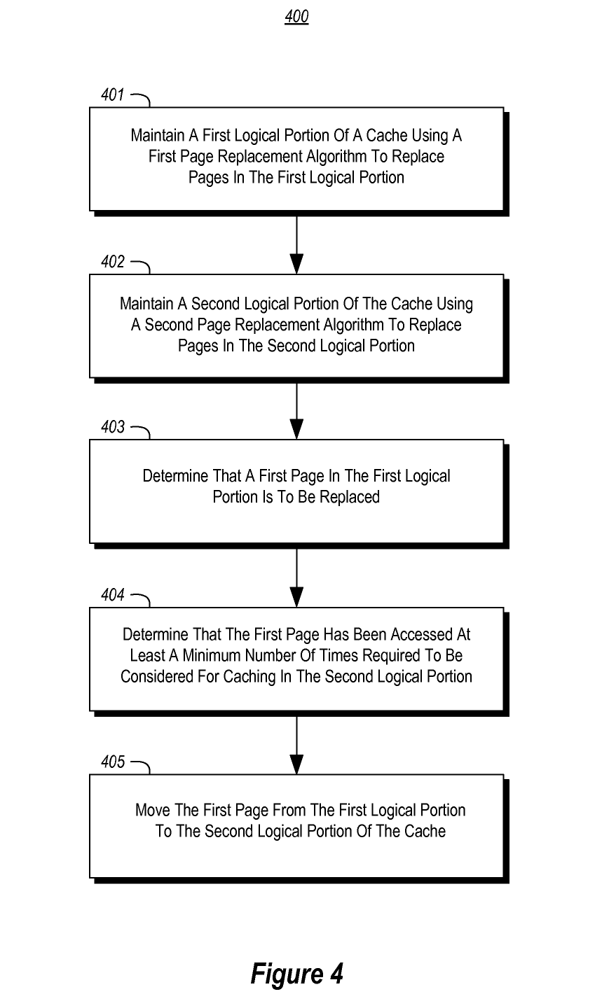

FIG. 4 illustrates a flow chart of an exemplary method 400 for implementing a cache that employs multiple page replacement algorithms. Method 400 will be described with respect to FIGS. 2, 3A, and 3B.

Method 400 includes an act 401 of maintaining a first logical portion of a cache using a first page replacement algorithm to replace pages in the first logical portion. For example, cache 203 implemented in memory 204 can include a first logical portion 301 which implements a first page replacement algorithm such as the LRU algorithm.

Method 400 includes an act 402 of maintaining a second logical portion of the cache using a second page replacement algorithm to replace pages in the second logical portion. For example, cache 203 can include a second logical portion 302 which implements a second page replacement algorithm such as the LRU2 algorithm.

Method 400 includes an act 403 of determining that a first page in the first logical portion is to be replaced. For example, in response to a request to access an uncached page 310 from disk, it can be determined that page 1 in first logical portion 301 is to be discarded from the first logical portion to make room for page 310. Page 1 can be identified for replacement by applying the LRU algorithm to determine that page 1 is the least recently used page in first logical portion 301.

Method 400 includes an act 404 of determining that the first page has been accessed at least a minimum number of times required to be considered for caching in the second logical portion. For example, it can be determined that page 1 has been accessed at least two times as required by the LRU2 algorithm implemented in second logical portion 302.

Method 400 includes an act 405 of moving the first page from the first logical portion to the second logical portion of the cache. For example, page 1 can be moved from first logical portion 301 to second logical portion 302. Moving page 1 can comprise physically relocating page 310 within the cache, or can comprise logically moving page 1 (such as by changing pointers or other data values within a data structure that identifies pages in a particular portion of the cache).

Although method 400 has primarily been described using LRU and LRU2 as the examples of the first and second page replacement algorithms, the invention extends to using any other two (or more) page replacement algorithms in method 400. For example, any combination of LRU, LRU2, LRU3, LRU4, etc. can be used.

Further, method 400 can be employed within any computer environment to implement any cache. The following example of a server cluster environment is just one example of the type of environment in which the caching techniques of the present invention can be employed.

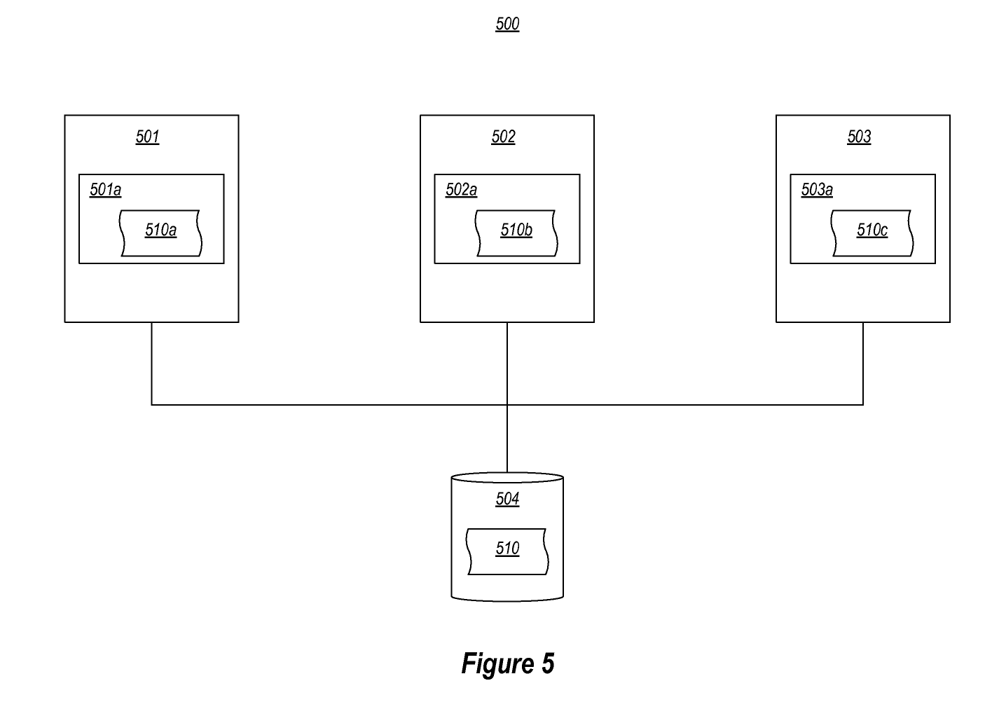

FIG. 5 illustrates an exemplary server architecture 500 in which a cache that employs multiple page replacement algorithms may be used. FIG. 5 includes servers 501, 502, and 503, and a storage array 504 to which each server is connected. Each of servers 501-503 include memory 501a-503a respectively in which a cache can be implemented. In some embodiments, each of servers 501, 502, and 503 can be a node of a cluster. For example, each server can host a plurality of virtual machines that are each deployed from a parent virtual hard disk that is stored on storage array 504.

Since a plurality (e.g. 100) of virtual machines may be executing on a given server, the parent virtual hard disk (which stores the operating system image for each virtual machine) can be accessed frequently. In particular, many of the virtual machines can frequently access the same pages of the virtual hard disk. As described, accesses to the virtual hard disk can be performed (and typically are performed) as unbuffered I/O (meaning the accessed pages are not cached). In the present invention, these accesses to the virtual hard disk are performed via unbuffered I/O, however, a cache (separate from the cache used for buffered I/O), referred to herein as the block cache, can be implemented to cache pages accessed via the unbuffered I/O.

In one example using the Windows operating system, buffered I/O is cached in the operating system cache (or file cache) using the LRU algorithm. The present invention can implement a separate cache, the block cache, for caching pages accessed via unbuffered I/O such as pages of a virtual hard disk (parent or child) accessed by a virtual machine. These techniques can be applied equally to other operating systems or caching schemes. In other words, the caching of unbuffered I/O can be performed in any environment/operating system according to the present invention.

A block cache for caching pages accessed via unbuffered I/O can be implemented to use multiple page replacement algorithms as described above. In the server cluster example, implementing multiple page replacement algorithms increases the efficiency of the block cache (i.e. a greater number of pages of the virtual hard disks that are most frequently accessed are maintained in cache).

In this manner, the number of I/O per second (IOPS) to storage array 504 is reduced in the cluster because once a page is accessed from storage array 504, it will be cached in the block cache on the node so that subsequent requests to access the page (whether by the same virtual machine or another virtual machine on the node) can be satisfied by accessing the cached page rather than accessing the page on storage array 504. Storage array 504 may be connected to servers 501-503 over a network (or other relatively slower connection as compared to cache). This can reduce I/O thus greatly increased performance of the virtual machines in the cluster.

FIG. 5 shows that virtual hard disk 510 is stored on storage array 504 and that portions (i.e. pages) 510a-510c of virtual hard disk 510 are cached on each of servers 501-503 respectively. For example, portion 510a can represent the pages of virtual hard disk 510 that have been cached for access by virtual machines executing on server 501. Although not shown, a child virtual disk for each virtual machine on servers 501-503 can also be stored on storage array 504. Portions of these child virtual disks can also be cached, with the cached portions of the parent virtual disk, on the node where the corresponding virtual machine is executing.

In embodiments of the invention, caches can be synchronized. For example, because the same pages of data stored on storage array 504 can be cached at different nodes, it can be necessary to synchronize caches between nodes. For example, if a page is cached on two or more nodes, and the cached page is updated on one of the nodes, the caches on the other nodes will need to be synchronized.

Synchronization of caches can be performed by sending updates to cached pages to nodes where the same page is cached so that the updates are reflected in each cached copy of the page. In other embodiments, when a cached page is updated, the updates can be written to the virtual disk in storage array 504 and a notification can be sent to other nodes in the cluster to indicate that any copies of the updated cached page should be discarded thus causing subsequent requests for the page to be satisfied by accessing the page from storage array 504. Accordingly, the techniques of the present invention can be used to implement a distributed cache for caching unbuffered I/O in a server cluster environment.

This synchronization can be implemented in a similar manner as described in commonly owned patent application Ser. No. 12/971,322, titled Volumes And File System In Cluster Shared Volumes, which describes embodiments for coordinating caches on different nodes of a cluster using oplocks. The techniques described in that application apply to caches of buffered I/O content. Similar techniques can be applied in the present invention to synchronize caches of unbuffered I/O content.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for implementing a cache that employs multiple page replacement algorithms, the method comprising:
maintaining a first logical portion of a cache using a first page replacement algorithm to replace pages in the first logical portion;
maintaining a second logical portion of the cache using a second page replacement algorithm to replace pages in the second logical portion;
determining that a first page in the first logical portion is to be replaced;
determining that the first page has been accessed at least a minimum number of times required to be considered for caching in the second logical portion; and
moving the first page from the first logical portion to the second logical portion of the cache.

2. The method of claim 1, wherein the first page replacement algorithm is the least recently used (LRU) algorithm, and the second page replacement algorithm is the least recently used 2 (LRU2) algorithm.

3. The method of claim 2, wherein determining that the first page in the first logical portion is to be replaced comprises determining that a new page is to be added to the first logical portion of the cache, and determining that the first page is the least recently used page in the first logical portion.

4. The method of claim 2, wherein the minimum number of accesses is two, the method further comprising:
prior to moving the first page from the first logical portion to the second logical portion of the cache, determining that the second to last access of the first page is more recent than the second to last access of at least one other page in the second logical portion.

5. The method of claim 4, wherein moving the first page from the first logical portion to the second logical portion of the cache includes removing another page from the second logical portion whose second to last access is the least recent of all other pages in the second logical portion.

6. The method of claim 1, further comprising:
maintaining one or more additional logical portions of the cache, wherein each of the one or more additional logical portions of the cache use a different page replacement algorithm than each logical portion above the additional logical portion.

7. The method of claim 6, wherein the one or more additional logical portions of the cache comprise a third logical portion that uses the least recently used three (LRU3) page replacement algorithm.

8. The method of claim 1, wherein the cache comprises a block cache for caching portions of one or more virtual hard disks that are accessed by a plurality of virtual machines.

9. The method of claim 1, wherein maintaining a first and second logical portion of the cache comprises caching pages when the pages are accessed via unbuffered I/O.

10. The method of claim 8, wherein the block cache is maintained on a node of a cluster.

11. The method of claim 10, wherein a block cache is maintained on each node of a cluster of nodes.

12. The method of claim 11, further comprising:
in response to an update to one or more pages of a first virtual hard disk of the one or more virtual hard disks, invalidating each cached version of the one or more updated pages in the block cache on each of the nodes.

13. The method of claim 1, further comprising:
determining that a second page in the first logical portion is to be replaced;
determining that the second page has not been accessed more than once; and
removing the second page from the cache.

14. The method of claim 11, wherein each block cache in the cluster of nodes is coordinated using oplocks.

15. A computer program product comprising one or more computer storage devices storing computer executable instructions which when executed by one or more processors perform a method for implementing a cache that employs multiple page replacement algorithms, the method comprising:
logically dividing a cache into a first and a second logical portion;
implementing the least recently used (LRU) page replacement algorithm on pages stored in the first logical portion;
implementing the least recently used two (LRU2) page replacement algorithm on pages stored in the second logical portion;
wherein pages removed from the first logical portion according to the LRU algorithm are moved into the second logical portion if the pages have been accessed at least two times during a monitored time span.

16. The computer program product of claim 15, wherein the cache is a block cache for caching pages accessed via unbuffered I/O.

17. The computer program product of claim 16, wherein each page is a page of a virtual hard disk.

18. The computer program product of claim 17, wherein the virtual hard disk is either a read-only parent virtual hard disk or a child virtual hard disk.

19. The computer program product of claim 15, wherein the cache is maintained on a node of a cluster of nodes.

20. A system comprising:
a cluster of server nodes, each server node executing a plurality of virtual machines;
a storage array connected to each server node in the cluster, the storage array comprising one or more storage devices storing a read-only virtual hard disk that is used by each of the plurality of virtual machines;
wherein each server node includes a block cache for caching pages of the read-only virtual hard disk that are accessed by virtual machines on the server node via unbuffered I/O;
wherein each block cache is logically divided into a first and a second logical portion, the first logical portion implementing the least recently used (LRU) page replacement algorithm on pages stored in the first logical portion, the second logical portion implementing the least recently used two (LRU2) page replacement algorithm on pages stored in the second logical portion; and
wherein pages removed from the first logical portion according to the LRU algorithm are moved into the second logical portion if the pages have been accessed at least two times during a monitored time span.
